(19) United States
(12) Patent Application Publication
(10) Pub. No.: US 2025/0245448 A1
(43) Pub. Date: Jul. 31, 2025

(54) INFORMATION PROCESSING METHOD, ELECTRONIC DEVICE, AND STORAGE MEDIUM

(71) Applicant: Lenovo (Beijing) Limited, Beijing (CN)

(72) Inventors: Yulong LI, Beijing (CN); Ying TIAN, Beijing (CN)

(21) Appl. No.: 19/015,554

(22) Filed: Jan. 9, 2025

(30) Foreign Application Priority Data
Jan. 31, 2024 (CN) 202410141187.0

(51) Int. Cl. G06F 40/40; G06F 40/279; G06F 40/35

(52) U.S. Cl. CPC G06F 40/40; G06F 40/279; G06F 40/35

(57) ABSTRACT

An information processing method, an electronic device, and a storage medium are provided in the present disclosure. The information processing method includes in response to obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

### CROSS-REFERENCE TO RELATED APPLICATION

This application claims the priority of Chinese Patent Application No. 202410141187.0, filed on Jan. 31, 2024, the content of which is incorporated herein by reference in its entirety.

### TECHNICAL FIELD

The present disclosure generally relates to the field of artificial intelligence technology, and, more particularly, relates to an information processing method, an electronic device, and a storage medium.

### BACKGROUND

With continuous development of artificial intelligence technology, human-computer interaction systems have received more attention. Currently, various industries have begun to apply human-computer interaction systems to customer service, smart home control, education and other fields to improve work efficiency and user experience.

At present, in order to provide a smoother interactive experience, introducing large language models (LLM) with memory and powerful natural language processing capabilities into human-computer interaction systems has become a research hotspot.

Current human-computer interaction systems directly input the users' input messages into large language models and feedback the processing results obtained by the large language models to the users. However, large language models may easily cause hallucination problems. For example, the content generated by the large language models may not match the actual situations, or generated content may be irrelevant to the input messages or the like, which may result in low reliability of current human-computer interaction systems.

### SUMMARY

One aspect of the present disclosure provides an information processing method. The method includes in response to obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

Another aspect of the present disclosure provides an electronic device. The electronic device includes a memory, configured to store a computer program; and one or more processors, configured to, when the computer program is executed, perform an information processing method. The method includes in response to obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

Another aspect of the present disclosure provides a non-transitory computer-readable storage medium, containing a computer program for when executed by one or more processors, performing an information processing method. The method includes in response to obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

Other aspects of the present disclosure may be understood by those skilled in the art in light of the description, the claims, and the drawings of the present disclosure.

### BRIEF DESCRIPTION OF THE DRAWINGS

In order to more clearly illustrate the technical solutions of embodiments of the present disclosure, the drawings needed for embodiments are briefly introduced below. Obviously, the drawings described below are only some embodiments of the present disclosure. For ordinary technicians in this field, other drawings may be obtained based on these drawings without creative work.

FIG. 1 illustrates an implementation flowchart of an information processing method according to various embodiments of the present disclosure.

FIG. 2 illustrates an implementation flowchart of inputting a first response message into at least one target large language model and outputting a second response message according to various embodiments of the present disclosure.

FIG. 3 illustrates an implementation flowchart of inputting a first response message into at least one target large language model according to various embodiments of the present disclosure.

FIG. 4 illustrates another implementation flowchart of inputting a first response message into at least one target large language model according to various embodiments of the present disclosure.

FIG. 5 illustrates another implementation flowchart of inputting a first response message into at least one target large language model according to various embodiments of the present disclosure.

FIG. 6 illustrates another implementation flowchart of an information processing method according to various embodiments of the present disclosure.

FIG. 7 illustrates another implementation flowchart of an information processing method according to various embodiments of the present disclosure.

FIG. 8 illustrates another implementation flowchart of an information processing method according to various embodiments of the present disclosure.

FIG. 9 illustrates another implementation flowchart of an information processing method according to various embodiments of the present disclosure.

FIG. 10 illustrates another implementation flowchart of an information processing method according to various embodiments of the present disclosure.

FIG. 11 illustrates a structural schematic of an information processing apparatus according to various embodiments of the present disclosure.

FIG. 12 illustrates a structural schematic of an electronic device according to various embodiments of the present disclosure.

The terms “first”, “second”, “third”, “fourth” and the like (if any) in the specification, the claims and above drawings may be configured to distinguish similar parts and may be not necessarily configured to describe a specific order or sequence. It should be understood that the numbers used in such way may be interchanged where appropriate, such that embodiments of the present disclosure described herein may be implemented in an order other than that illustrated in drawings herein.

### DETAILED DESCRIPTION

Before describing the solution of the present disclosure, the relevant concepts are explained.

Prompt is described in the following. When talking to AI (such as a large language model), a prompt may need to be sent to AI. The prompt may be a text description, such as “Please recommend me a pop music” when you are talking to AI; or may be a parameter description in a certain format, such as asking AI to draw in a certain format and describe relevant drawing parameters.

Large Language Models (LLM) refer to language models built with super large amount of parameters based on technologies such as probabilistic graphical models or recurrent neural networks. Large Language Models may be used for natural language processing tasks such as machine translation, text generation, question-answering systems and the like. The advantage of large language models may be that the models may understand and generate natural language, thereby achieving a more intelligent interaction manner. Common large language models may include GPT and large language models developed by other companies.

The technical solutions in embodiments of the present disclosure are clearly and completely described below with reference to the accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

An information processing method provided in embodiments of the present disclosure may be used for an electronic device. The electronic device may be a terminal device, such as a computer, an all-in-one machine, a laptop computer, a mobile phone or the like; and may also be a server or a server cluster.

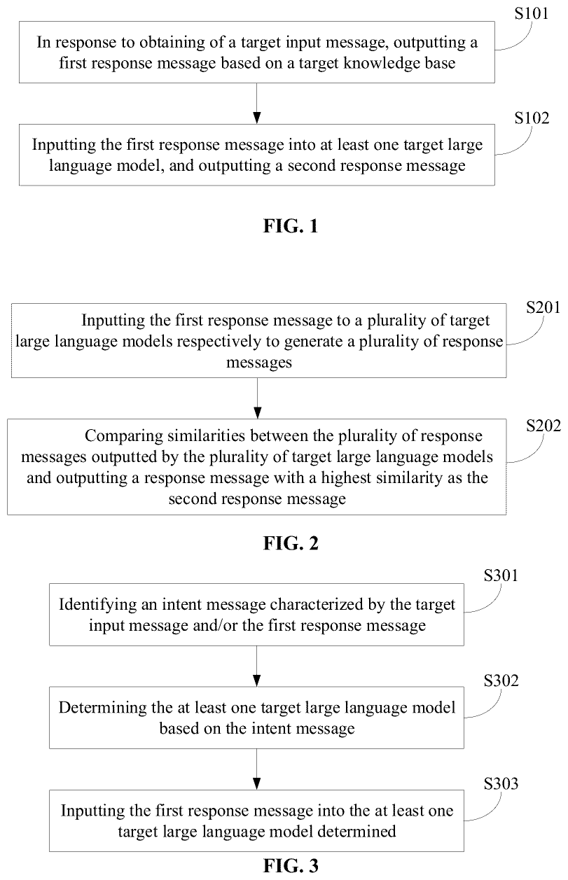

FIG. 1 illustrates an implementation flowchart of an information processing method according to various embodiments of the present disclosure. Referring to FIG. 1, the method may include following exemplary steps.

At S101, in response to obtaining of a target input message, the first response message may be outputted based on a target knowledge base.

The target input message may be a piece of text, a picture, or a voice.

The target input message may be input message received through a human-computer interaction interface; or may be interactive data read from a target application (i.e., interactive data inputted by a user in a target application, or interactive data selected by a user in a target application); or may be feedback message read from an external device.

When the target input message is text, the text may be inputted through a character input device; or may be obtained by performing text recognition on an image; or may be obtained by performing voice recognition on a voice.

The target knowledge base may be a local knowledge base, such that the first response message may be the response message outputted by the local knowledge base; or the first response message may be the message after the response message outputted by the local knowledge base is expanded; or the first response messages may be the message after the response message outputted by the local knowledge base is expanded and the message after the target input message is expanded. The local knowledge base may be a text knowledge base or a multimodal knowledge base (i.e., the knowledge base may include knowledge in the text mode and knowledge in other modes (e.g., picture, voice, video and the like)). The knowledge in the local knowledge base may be collected from a plurality of bottom terminals. The collected message may include, but may be not limited to, the user's personal background knowledge, the user's behavior habit data in the third-party platform (including but not limited to the data that the user frequently views) and the like. The data collected from different terminals may be associated through the user identifiers. Exemplarily, the data collected from different terminals associated with same user identifier may be associated and stored in a wide column.

Or the target knowledge base may be a large language model (referred to as the first large language model for ease of description and distinction), such that the first response message may be the response message outputted by the first large language model; or the first response message may be the message after the response message outputted by the first large language model is expanded; or the first response message may be the messages after the response message outputted by the first large language model is expanded and the message after the target input message is expanded. The first large language model may be obtained by training the first knowledge base, and the first knowledge base may be different from the local knowledge base. Exemplarily, the response message outputted by the first large language model may be expanded by the large language model.

Or the target knowledge base may be the local knowledge base and the first large language model, such that the first response message may be the response message obtained by inputting the response message outputted from the local knowledge base into the first large language model; or the first response message may be the message after the response message outputted from the first large language model is expanded; or the first response messages may be the message after the response message outputted by the first large language model is expanded and the message after the target input message is expanded; or the first response message may be the response message obtained by integrating the response message output based on the local knowledge base and the response message outputted by the first large language model. The first large language model may be obtained by training the first knowledge base, and the first knowledge base may be different from the local knowledge base.

The first knowledge base may include knowledge in a plurality of domains. That is, the first knowledge base may be a general knowledge base; and accordingly, the first large language model may be a general large language model.

Above-mentioned extension of the response message or the target input message may include, but may be not limited to, at least one of the following extensions, including semantic extension, adding scenario, determining domain (i.e. limiting application domain), specifying scope and the like.

The difference between the first large language model and the local knowledge base may be that the first large language model may be a generative model which may generate new messages based on the input messages; while the local knowledge base cannot generate new messages and may only search and match in existing knowledge.

At S102, the first response message may be inputted into at least one target large language model, and the second response message may be outputted.

The target large language model may be different from the target knowledge base, and the matching degree between the second response message and the target input message may be higher than the matching degree between the first response message and the target input message.

The target large language model may be a domain large model, and each target large language model may be trained based on the domain knowledge base of the domain to which the large language model belongs.

The target large language model may be also a generative model, which may be configured to generate new messages based on the input messages.

When the first response message is inputted into N (N is an integer greater than 1) target large language models, the response messages outputted by the N target large language models may be directly configured as the second response message; or the response messages outputted by the N target large language models may be compared to determine final response message as the second response message.

The matching degree between the second response message and the target input message may be higher than the matching degree between the first response message and the target input message, which may indicate that the second response message is more accurate than the first response message.

For the information processing method provided in embodiments of the present disclosure, the target input message may be no longer directly inputted into the large language model, but the first response message may be first obtained based on the target knowledge base; and the first response message may be processed through one or more target large language models to obtain the second response message. In such way, the second response message may have a higher matching degree with the target input message, thereby improving the reliability of human-computer interaction.

In an optional embodiment, an implementation manner of above-mentioned outputting the first response message based on the target knowledge base in response to the obtaining of the target input message may be extracting keyword(s) from the target input message in response to the obtaining of the target input message.

When the target input message is a picture, voice or video, the picture, voice or video may be converted into text first, and the text may be subjected to keyword extraction.

The extracted keyword may be inputted into the local knowledge base of the electronic device and/or the first large language model to output the first response message.

In one embodiment, keyword-related question-answer pair search may be only performed, or the response message corresponding to the keyword may be generated based on the first large language model.

Optionally, the keyword may be directly inputted into the local knowledge base for search, and the searched content matching the keyword may be configured as the first response message. Exemplarily, the keyword search may be performed in the local knowledge base. In response to that the keyword is searched (the keyword may be same keyword as the extracted keyword, or a keyword that the matching degree with the extracted keyword is greater than a threshold), the knowledge corresponding to the searched keyword may be configured as the first response message.

Optionally, the keyword may be directly inputted into the first large language model, and the response message generated by the first large language model may be configured as the first response message. Or the response message generated by the first large language model may be inputted into the first large language model again, and the first large language model may expand the response message to obtain the expanded response message as the first response message.

Optionally, the keyword may be first inputted into the local knowledge base for search. In response to that the content matching the keyword is searched, the searched content may be configured as the first response message. In response to that the content matching the keyword is not searched, the keyword may be inputted into the first large language model, and the response message generated by the first large language model may be configured as the first response message.

In an optional embodiment, another implementation manner of above-mentioned outputting the first response message based on the target knowledge base in response to the obtaining of the target input message may be that in response to the obtaining of the target input message, after an enhancement processing is performed on the target input message, enhanced target input message may be inputted into the local knowledge base of the electronic device and/or the first large language model to output the first response message.

The enhancement of the target input message may include, but may be not limited to, any of the following: semantic expansion, intent expansion and the like.

In an optional embodiment, another implementation manner of above-mentioned outputting the first response message based on the target knowledge base in response to the obtaining of the target input message may be that in response to the obtaining of the target input message, determine to output the first response message using the local knowledge base of the electronic device and/or the first large language model based on the attribute message and/or content of the target input message.

The attribute message of the target input message may include, but may be not limited to, format attributes (such as text, pictures, voice, video and the like), source attributes (from local target applications, from local sensors, from local acquisition modules, from external devices and the like), data volume and the like.

The content of the target input message may include, but may be not limited to, keyword of the target input message, instruction message carried by the target input message, and the like.

In above-mentioned embodiments, whether the first response message is outputted using the local knowledge base of the electronic device or using the first large language model may be predetermined. However, in one embodiment, whether the first response message is outputted using the local knowledge base of the electronic device or using the first large language model may be determined according to the attribute message and/or content of the target input message. That is, the manner of processing the target input message to output the first response message may be different according to different attributes and/or contents of the target input message.

For above-mentioned three implementation manners of outputting the first response message based on the target knowledge base in response to the obtaining of the target input message, only one implementation manner may be deployed, or two or three implementation manners may be deployed simultaneously. In the case of deploying two or three implementation manners simultaneously, only one implementation manner may be selected to output the first response message each time.

In an optional embodiment, an implementation manner of, after the enhancement processing is performed on the target input message, inputting enhanced target input message into the local knowledge base of the electronic device and/or the first large language model to output the first response message may be that, after extracting the keyword from the target input message, keyword expansion processing may be performed and/or intent expansion processing may be performed on the target input message, and the message data after expansion processing may be inputted into the local knowledge base of the electronic device or the first large language model to output the first response message.

Optionally, the keyword expansion processing may be synonym expansion, such that the message data after the expansion processing may include the extracted keyword and synonyms thereof. Based on the above, the extracted keyword and synonyms thereof may be inputted together into the local knowledge base of the electronic device to obtain the first response message outputted by the local knowledge base; or the extracted keyword and synonyms thereof may be inputted together into the first large language model to obtain the first response message outputted by the first large language model.

Optionally, the keyword expansion processing may be to integrate the target input message with each keyword separately (e.g., by splice, concatenation, etc.); or in other embodiments, may be to spice and integrate the image after the input image is expanded (e.g., similar image) with the input image; or may be to spice and integrate the key object in the input image after expansion (e.g., a similar key object) with the input image; or may be to spice and integrate the key object in the input image after expansion with the key object in the input image; or may be to spice and integrate a plurality of input images; or may be to spice and integrate the key objects in the plurality of input images. In addition, in the voice scenario, the expanded voice (for example, voice with similar semantics) of the input voice may be spliced and integrated with the input voice; or the key segments in the input voice after expansion (for example, voice segments with similar semantics) may be spliced and integrated with the input voice; or a plurality of input voices may be spliced and integrated with each other; or the key segments in the plurality of input voices may be spliced and integrated with each other. Exemplarily, the target input message may be segmented, and for any key word, the keyword and each segmentation may be inputted into the local knowledge base of the electronic device together to obtain the first response message outputted by the local knowledge base; or any keyword and each segmentation may be inputted into the first large language model together to obtain the first response message outputted by the first large language model. In the present disclosure, the target input message may be integrated with the keywords; and the use scenario, intent and the like of the questioner may be determined through some modifiers in the target input message.

Optionally, the intent expansion of the target input message may be same intent expansion. Therefore, the message data after the expansion processing may include the target input message, and the sentences characterizing same or similar intent as the target input message; or the message data after the expansion processing may include extracted keywords and similar intent keywords. Same intent keywords may be keywords extracted from the sentences characterizing same or similar intent as the target input message. Based on the above, the target input message and the sentences characterizing same or similar intent as the target input message may be inputted into the first large language model together to obtain the first response message outputted by the first large language model; or the extracted keywords and same intent keywords may be inputted into the local knowledge base or the first large language model of the electronic device together to obtain the first response message outputted by the local knowledge base or the first response message outputted by the first large language model.

In an optional embodiment, an implementation manner of, after the enhancement processing is performed on the target input message, inputting enhanced target input message into the local knowledge base of the electronic device and/or the first large language model to output the first response message may be that after extracting the keyword from the target input message, the response message matching the keyword may be obtained from the local knowledge base of the electronic device; and in response to that matching response message is not obtained, after performing the keyword expansion processing, a keyword expansion processing result may be inputted into the local knowledge base or the first large language model to output the first response message.

Unlike previous embodiment that the keyword and/or target input message are directedly expanded, in one embodiment, after the keyword is extracted from the target input message, the response message matching the keyword may be searched first from the local knowledge base based on the extracted keyword. in response to that the response message matching the keyword is found, the searched response message may be configured as the first response message. in response to that the response message matching the keyword is not searched, the expansion processing (a synonym expansion or a same intent keyword expansion, and the manner for obtaining same intent keyword may refer to above-mentioned embodiments) may be performed on the keyword; and the first response message may be obtained based on the keywords after expansion (including the extracted keyword and the expanded keyword). For example, the response message matching the expanded keyword may be obtained from the local knowledge base of the electronic device as the first response message; or the expanded keyword may be inputted into the first large language model to obtain the first response message outputted by the first large language model.

In an optional embodiment, an implementation manner of, after the enhancement processing is performed on the target input message, inputting enhanced target input message into the local knowledge base of the electronic device and/or the first large language model to output the first response message may be that after extracting the keyword from the target input message, the response message matching the keyword may be obtained from the local knowledge base of the electronic device; and in response to that no matching response message is obtained, the target input message after the intent expansion processing may be inputted into the first large language model to output the first response message.

Similar to previous embodiment, in one embodiment, after extracting the keyword from the target input message, the response message matching the keyword may be searched first from the local knowledge base based on the keyword; and in response to that the response message matching the keyword is found, the searched response message may be configured as the first response message.

Different from previous embodiment, when the response message matching the keyword is not found in the local knowledge base, the keyword may be expanded in previous embodiment; while in one embodiment, the intent expansion may be performed on the target input message, the messages after the intent expansion (including the target input message and the sentences with same or similar intent as the target input message) may be inputted into the first large language model, and the response message outputted by the first large language model may be configured as the first response message.

For above-mentioned three implementation manners of inputting enhanced target input message into the local knowledge base of the electronic device and/or the first large language model to output the first response message, only one implementation manner may be deployed, or two or three implementation manners may be deployed simultaneously. In the case of deploying two or three implementation manners simultaneously, only one implementation manner may be selected to output the first response message each time.

In an optional embodiment, an implementation manner of determining to output the first response message using the local knowledge base of the electronic device and/or the first large language model based on the attribute message and/or content of the target input message may be, based on the format attributes of the target input message and/or characterized intent content, determining to output the first response message using the local knowledge base of the electronic device and/or the first large language model. Intent content may refer to the semantics or domain of the target input message.

Optionally, it determines that the first response message may be outputted using the local knowledge base or the first largest language model based on different format attributes of the target input message.

Exemplarily, in response to that the target input message is any one of text or document image or voice, the local knowledge base may be selected to output the first response message; and in response to that the target input message is a video or non-document image, the first largest language model may be selected to output the first response message.

Exemplarily, in response to that the target input message is any one of text or voice, the local knowledge base may be selected to output the first response message; and in response to that the target input message is a video or picture, the first large language model may be selected to output the first response message.

Exemplarily, in response to that the target input message is text, the local knowledge base may be selected to output the first response message; in response to that the target input message is a picture or voice, the first largest language model may be selected to output the first response message (the picture or voice may be converted into text and then inputted into the first largest language model); and in response to that the target input message is a video, the local knowledge base and the first largest language model may be selected to output the first response message (the video may be converted into text and then inputted into the local knowledge base and/or the first largest language model).

Optionally, it determines that the first response message may be outputted using the local knowledge base or the first largest language model based on the different intent contents of the target input message.

Exemplarily, in response to that the semantics of the target input message belongs to the first category of semantics, the local knowledge base may be selected to output the first response message; and in response to that the semantics of the target input message belongs to the second category of semantics, the first largest language model may be selected to output the first response message. That is, in one embodiment, the semantics may be divided into two categories, one category of semantics may correspond to the local knowledge base, and another category of semantics may correspond to the first largest language model.

Exemplarily, in response to that the domain of the target input message belongs to the first category of domains, the local knowledge base may be selected to output the first response message; and in response to that the domain of the target input message belongs to the second category of domains, the first largest language model may be selected to output the first response message. That is, in one embodiment, the domains may be divided into two categories, one category of domains may correspond to the local knowledge base, and another category of domains may correspond to the first largest language model.

Exemplarily, in response to that the domain of the target input message belongs to the first category of domains, the local knowledge base may be selected to output the first response message; in response to that the domain of the target input message belongs to the second category of domains, the first largest language model may be selected to output the first response message; and in response to that the domain of the target input message belongs to the third category of domains, the local knowledge base and the first largest language model may be selected to output the first response message. That is, in one embodiment, the domains may be divided into three categories, one category of domains may correspond to the local knowledge base, another category of domains may correspond to the first largest language model, and another category of domains may correspond to the local knowledge base and the first largest language model.

Optionally, it determines that the first response message may be outputted using the local knowledge base or the first large language model based on different format attributes and/or intent contents of the target input message.

Exemplarily, in response to that the format attribute of the target input message belongs to the first type of format attributes and the intent content of the target input message belongs to the first type of intent contents, the local knowledge base may be selected to output the first response message; in response to that the format attribute of the target input message belongs to the second type of format attributes and the intent content of the target input message belongs to the second type of intent contents, the local knowledge base may be selected to output the first response message; otherwise, the local knowledge base and the first large language model may be selected to output the first response message.

In an optional embodiment, an implementation manner of determining to output the first response message using the local knowledge base of the electronic device and/or the first large language model based on the attribute message and/or content of the target input message may be determining to output the first response message using the local knowledge base of the electronic device and/or the first large language model based on the source attribute and/or the intent content characterized by the target input message.

Optionally, it determines that the first response message may be outputted using the local knowledge base or the first largest language model based on different sources of the target input message.

Exemplarily, in response to that the target input message is from the local target application, the local sensor or the local module, the local knowledge base may be selected to output the first response message; and in response to that the target input message is from other devices (i.e., an external device of the electronic device), the first largest language model may be selected to output the first response message.

Exemplarily, in response to that the target input message is from the local target application, the local knowledge base may be selected to output the first response message; in response to that the target input message is from the local sensor or the local module, the local knowledge base and the first large language model may be selected to output the first response message; and in response to that the target input message is from other devices (i.e., an external device of the electronic device), the first large language model may be selected to output the first response message.

Exemplarily, in response to that the target input message is from the local target application, the local sensor or the local module, and the intent content characterized by the target input message is the first type of intent contents, the local knowledge base may be selected to output the first response message; in response to that the target input message is from the local target application, the local sensor or the local module, and the intent content characterized by the target input message is the second type of intent contents, the local knowledge base and the large language model may be selected to output the first response message; and in response to that the target input message is from other devices (i.e., an external device of the electronic device), the first large language model may be selected to output the first response message.

In an optional embodiment, an implementation manner of determining to output the first response message using the local knowledge base of the electronic device and/or the first large language model based on the attribute message and/or content of the target input message may be determining to output the first response message using the local knowledge base and/or the first largest language model of the electronic device based on the data volume attribute of the target input message and/or carried instruction content.

The data volume attribute may refer to the data volume of the target input message or the number of keywords extracted from the target input message.

The instruction content carried in the target input message may indicate that the first response message may be outputted using the local knowledge base of the electronic device or indicate that the first response message may be outputted using the first large language model.

Exemplarily, in response to that the data volume of the target input message is less than the target data volume or the number of extracted keywords is less than a target number, it indicates that the problem may be relatively simple, and the local knowledge base may be selected to output the first response message; in response to that the data volume of the target input message is greater than or equal to the target data volume, or the number of extracted keywords is greater than or equal to the target number, the first large language model may be selected to output the first response message.

Exemplarily, in response to that the data volume of the target input message is less than the first target data volume or the number of extracted keywords is less than the first target number, it indicates that the problem may be relatively simple, and the local knowledge base may be selected to output the first response message; in response to that the data volume of the target input message is greater than or equal to the first target data volume and less than or equal to the second target data volume, or the number of extracted keywords is greater than or equal to the first target number and less than or equal to the second target number, the first large language model may be selected to output the first response message; in response to that the data volume of the target input message is greater than the second target volume, or the number of extracted keywords is greater than the second target number, the local knowledge base and the first large language model may be selected to output the first response message. The second target data volume may be greater than the first target data volume, and the second target number may be greater than the first target number.

Optionally, in response to that the target input message does not carry the instruction content, the local knowledge base or the first largest language model may be selected based on the data volume attribute of above target input message to output the first response message. in response to that the target input message carries the instruction content, the local knowledge base or the first largest language model may be selected based on the instruction content to output the first response message.

In above-mentioned embodiments, when the first response message is outputted based on the target knowledge base in response to the obtaining of the target input message, the response message outputted by the local knowledge base may be configured as the first response message, or the response message outputted by the first large language model may be configured as the first response message; and there is no interaction between the response message outputted by the local knowledge base and the response message outputted by the first large language model. In another implementation manner, the response message outputted by the local knowledge base and the response message outputted by the first large language model may be integrated (perform integration processing) to obtain the first response message, thereby further improving the matching degree between the first response message and the target input message.

In an optional embodiment, another implementation manner of outputting the first response message based on the target knowledge base in response to the obtaining of the target input message may be that in response to the obtaining of the target input message, the target input message may be inputted into the local knowledge base and the first large language model of the electronic device respectively; and after the target processing is performed on the response message outputted by the local knowledge base and the first large language model, the first response message may be outputted.

That is, in one embodiment, the target input message may be inputted into both the local knowledge base and the first large language model. When the target input message is inputted into the local knowledge base, the target input message may be directly inputted into the local knowledge base, the local knowledge base may extract the keyword from the target input message, and the matching content may be searched based on the extracted keyword; or the keyword may be extracted from the target input message first, and the extracted keyword may be inputted into the local knowledge base. Similarly, when the target input message is inputted into the first large language model, the target input message may be directly inputted into the first large language model, or the keyword may be extracted from the target input message first, and the extracted keyword may be inputted into the first large language model.

The target processing of the response messages respectively outputted by the local knowledge base and the first large language model may be to integrate the response messages respectively outputted by the local knowledge base and the first large language model to obtain the first response message.

In an optional embodiment, an implementation manner of above-mentioned target processing of the response messages respectively outputted by the local knowledge base and the first largest language model may be that different weights may be configured for the response message outputted by the local knowledge base (referred to as the third response message for the convenience of description and distinction) and the response message outputted by the first large language model (referred to as the fourth response message for the convenience of description and distinction); and the third response message and the fourth response message may be integrated based on corresponding weights to obtain the first response message.

The weight of the response message may represent the confidence of the response message. The greater the weight of the response message is, the higher the confidence of the response message is.

Optionally, the weight corresponding to the third response message (for ease of description and distinction, referred to as the first weight) may be greater than the weight corresponding to the fourth response message (for ease of description and distinction, referred to as the second weight).

Exemplarily, the first vector representation of the third response message and the second vector representation of the fourth response message may be obtained; the first vector representation may be processed based on above-mentioned first weight (for example, the first vector representation is multiplied by the first weight) to obtain the third vector representation; the second vector representation may be processed based on above-mentioned second weight (for example, the second vector representation is multiplied by the second weight) to obtain the fourth vector representation; the third vector representation and the fourth vector representation may be concatenated to obtain the first response message.

Exemplarily, the third response message, the first target message, the fourth response message and the second target message may be sequentially spliced, concatenated, or otherwise combined, to obtain the first response message. The first target message may indicate that the weight of the third response message is the first weight, and the second target message may indicate that the weight of the fourth response message is the second weight.

Exemplarily, the ratio of the first weight to the second weight may be obtained (for ease of description and distinction, referred to as the first ratio); and the third response message, the fourth response message and the third target message may be sequentially spliced, concatenated, or otherwise combined, to obtain the first response message. The third target message may represent that the confidence ratio of the third response message to the fourth response message is the first ratio.

In an optional embodiment, another implementation manner of above-mentioned target processing of the response messages respectively outputted by the local knowledge base and the first large language model may be that the match processing may be performed on the third response message outputted by the local knowledge base and the fourth response message outputted by the first large language model; and the response message that the matching degree reaches the first threshold may be determined as the first response message.

Optionally, the third response message and the fourth response message may be matched to determine the portion of two response messages that the matching degree is greater than or equal to the target matching degree; and such portion of two response messages may be determined as the first response message.

Exemplarily, the matching degree between the keywords of two response messages may be calculated, and the keyword with the matching degree greater than or equal to the target matching degree may be determined as the first response message; or the content containing the target keyword pair in two response messages may be determined as the first response message. The target keyword pair may be two keywords with the matching degree greater than or equal to the target matching degree, and two keywords may be located in different response messages.

In an optional embodiment, another implementation manner of above-mentioned target processing of the response messages respectively outputted by the local knowledge base and the first large language model may be obtaining the evaluation message of the third response message outputted by the local knowledge base and the fourth response message outputted by the first large language model, and outputting at least a part of the third response message and/or the fourth response message as the first response message based on the evaluation message.

In one embodiment, the third response message and the fourth response message may be outputted respectively, such that the user may evaluate the third response message and the fourth response message.

The user's evaluation of the response message may be the user's recognition of the response message, for example, may be the user's score for the response message. Optionally, an interactive page may be outputted, and the interactive page may display the third response message and corresponding scoring option and display the fourth response message and corresponding scoring option. Based on the above, the weight of the third response message may be determined based on the user's score on the third response message; the weight of the fourth response message may be determined based on the user's score on the fourth response message; and the third response message and the fourth response message may be integrated based on the weight of the third response message and the weight of the fourth response message (corresponding integration processing may refer to above-mentioned embodiments) to obtain the first response message.

The user's evaluation of the response message may be accuracy information including correct, wrong or not accurate enough. Optionally, the interactive page may be outputted; and the interactive page may display the third response message and corresponding evaluation option and display the fourth response message and corresponding evaluation option. Based on the above, the weight of the third response message may be determined based on the user's evaluation of the third response message, and the weight of the fourth response message may be determined based on the user's evaluation of the fourth response message. Next, the third response message and the fourth response message may be integrated based on the weight of the third response message and the weight of the fourth response message (corresponding integration processing may be referred to above-mentioned embodiments) to obtain the first response message. The weight corresponding to “correct” may be greater than the weight corresponding to “not accurate enough”; and the weight corresponding to “not accurate enough” may be greater than the weight corresponding to “wrong”.

The user's evaluation of the response message may be the content selected by the user in the response message and considered correct (e.g., a word or phrase or sentence). Based on the above, the selected content in the third response message (in response to that the user does not select, such part of the content is empty) and the selected content in the fourth response message (in response to that the user does not select, such part of the content is empty) may be determined as the first response message.

Optionally, in response to that the evaluation message of the fourth response message indicates that the user is not satisfied with the fourth response message (for example, the score of the fourth response message is equal to a target score; or the evaluation message is wrong or not accurate enough; or there is no selected content in the fourth response message; or the proportion of selected content in the fourth response message is less than a target proportion), the fourth response message, the evaluation message and the first prompt (the first instruction) may be inputted into the first large language model, such that the first large language model may amend the fourth response message based on the evaluation message, thereby generating a desirable fourth response message. The first prompt may instruct the first large language model to amend the fourth response message based on the evaluation message.

In an optional embodiment, another implementation manner of above-mentioned target processing of the response messages respectively outputted by the local knowledge base and the first large language model may be that the third response message outputted by the local knowledge base and the fourth response message outputted by the first large language model may be superimposed (perform superimposing processing) to obtain the first response message.

In one embodiment, the third response message and the fourth response message may be directly spliced, concatenated, or otherwise combined, to obtain the first response message.

For above-mentioned four implementation manners of the target processing of the response messages respectively outputted by the local knowledge base and the first large language model, only one implementation manner may be deployed, or two or three implementation manners may be deployed simultaneously. In the case of deploying two or three implementation manners simultaneously, only one implementation manner may be selected to output the first response message each time.

In an optional embodiment, when the local knowledge base performs knowledge search based on the keywords or other data (for example, the target input data, or the message data after expansion processing), the search may be performed based on the vector representation of the keywords or other data. In order to improve the efficiency of the local knowledge base in obtaining the response message, the index relationship between the vector representation of the keywords or other data and the local knowledge may be established in advance. Therefore, when indexing is needed, there may be no need to calculate the vector representation of the index of local knowledge, only the vector representation of the input keywords or other data may be calculated, and the search may be performed according to the distance between the vector representations (configured to measure the matching degree), thereby improving the efficiency of knowledge search.

In response to that the searched knowledge (i.e., response message) is non-text (e.g., pictures, voice, video), the searched knowledge may be converted into text for subsequent processing.

In an optional embodiment, an implementation flowchart of inputting the first response message into at least one target large language model and outputting the second response message disclosed above is illustrated in FIG. 2, which may include following exemplary steps.

At S201, the first response message may be inputted into the plurality of target large language models respectively to generate the plurality of response messages.

At S202, the similarities between the response messages outputted by all target large language models may be compared, and the response message with the highest similarity may be outputted as the second response message.

The similarity between the response messages generated by two target large language models may be calculated (the cosine distance between the vector representations of two response messages may be configured to represent the similarity between two response message), and two response messages with the highest similarity may be outputted as the second response message.

By outputting two response messages, the user may select the final response message, or the user may extract the final response message from two response messages, which may help the user quickly determine needed response message.

In an optional embodiment, an implementation flowchart of inputting the first response message into at least one target large language model disclosed above is illustrated in FIG. 3 and may include following exemplary steps.

At S301, the intent message characterized by the target input message and/or the first response message may be identified.

The pre-trained intent recognition model may be configured to perform intent recognition on the target input message to obtain the intent message characterized by the target input message.

Above-mentioned intent recognition model may be configured to perform intent recognition on the first response message to obtain the intent message characterized by the first response message.

Or above-mentioned intent recognition model may be configured to perform intent recognition on the target input message and the first response message respectively to obtain the intent message characterized by the target input message and the intent message characterized by the first response message.

At S302, the target large language model may be determined based on the identified intent message (the number of target large language models may be at least one), and the domain to which the target large language model belongs may be same as the domain to which the target input message and/or the first response message belongs.

Optionally, when only the intent message characterized by the target input message (referred to as the first intent message for ease of description and distinction) is obtained, the domain to which the target input message belongs (referred to as the first domain for ease of description and distinction) may be determined based on obtained first intent message, and the target large language model may be determined based on the first domain.

Optionally, when only the intent message characterized by the first response message (referred to as the second intent message for ease of description and distinction) is obtained, the domain to which the first response message belongs may be determined based on obtained second intent message (referred to as the second domain for ease of description and distinction), and the target large language model may be determined according to the first domain.

Optionally, in response to the obtaining the first intent message characterized by the target input message and the second intent message characterized by the first response message, and in response to that the first intent message and the second intent message represent same intent and the first domain is same as the second domain, the target large language model may be determined based on the first domain; otherwise, the target large language model cannot be determined. At this point, the first response message and the third prompt may be inputted into the first large language model, such that the first large language model may supplement or amend the first response message. Therefore, the intent message and domain of supplemented or amended first response message may be same as the intent message and domain of the target input message, and the target large language model may be determined based on the first domain.

At S303, the first response message may be inputted into at least one target large language model determined.

In response to supplementing or amending the first response message, newly generated first response message may be inputted into at least one target large language model determined.

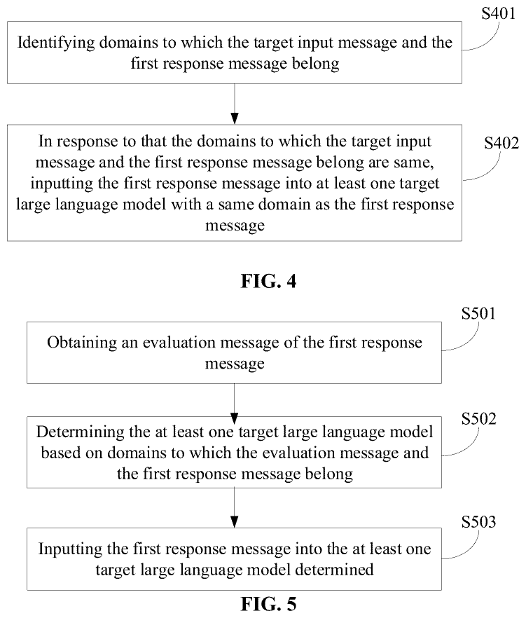

In an optional embodiment, another implementation flowchart of inputting the first response message into at least one target large language model disclosed above is illustrated in FIG. 4 and may include following exemplary steps.

At S401, the domains to which the target input message and the first response message belong may be identified.

Unlike an implementation shown in FIG. 3, in one embodiment, the intent of the target input message and the first response message may be not identified, but the domains to which the target input message and the first response message belong may be directly identified.

Optionally, the domain to which the target input message belongs and the domain to which the first response message belongs may be identified by a pre-trained domain recognition model.

At S402, when the domain to which the target input message belongs is same as the domain to which the first response message belongs, the first response message may be inputted into at least one target large language model with same domain.

Furthermore, when the domain to which the target input message belongs is different from the domain to which the first response message belongs, the first response message and the fourth prompt may be inputted into the first large language model, such that the first large language model may supplement or amend the first response message. Therefore, the domain to which the supplemented or modified first response message belongs may be same as the domain to which the target input message belongs, and the newly generated first response message may be inputted into at least one target large language model with same domain. The fourth prompt may instruct the large language model to supplement or amend the first response message.

In an optional embodiment, another implementation flowchart of inputting the first response message into at least one target large language model disclosed above is illustrated in FIG. 5 and may include following exemplary steps.

At S501, the evaluation message of the first response message may be obtained.

In the present disclosure, after obtaining the first response message, the first response message may be outputted to obtain the evaluation message fed back by the user for the first response message.

At S502, the target large language model may be determined based on the evaluation message and the domain to which the first response message belongs (the number of target large language models may be at least one).

The domain to which the first response message belongs may be determined based on the intent message of the first response message or may be determined directly based on the first response message. Corresponding implementation manner may refer to above-mentioned embodiments, which may not be described in detail herein.

Optionally, in response to that the evaluation message is the target evaluation message, it indicates that the user may be satisfied with the first response message, and the target large language model may be determined based on the domain to which the first response message belongs. In response to that the evaluation message is not the target evaluation message, it indicates that the user may be not satisfied with the first response message. The first response message, the evaluation message and the fifth prompt may be inputted into the first large language model, such that the first large language model may supplement or amend the first response message until the evaluation message received based on the supplemented or amended first response message is the target evaluation message; and the target large language model may be determined based on the domain to which the latest generated first response message belongs. The fifth prompt may instruct the large language model to supplement or amend the first response message according to the evaluation message.

At S503, the first response message may be inputted to at least one target large language model determined.

For above-mentioned three implementation manners of inputting the first response message into at least one target large language model, only one implementation manner may be deployed, or two or three implementation manners may be deployed simultaneously. In the case of deploying two or three implementation manners simultaneously, only one implementation manner may be selected to input the first response message to at least one target large language model each time.

When the first response message is inputted into any target large language model, the first response message and the sixth prompt may be inputted into any target large language model, and the sixth prompt may instruct any target large language model to continue writing on the basis of the first response message and add more details, thereby generating a more detailed and rich answer.

In an optional embodiment, an implementation manner of outputting the second response message may be obtaining the evaluation message of the plurality of response messages generated by the plurality of target large language models and determining at least one of the plurality of response messages as the second response message based on the evaluation message.

In one embodiment, the evaluation message of any response message generated by any target large language model may include a historical evaluation message. The historical evaluation message may be the evaluation message for any response message received after any target large language model generates and outputs the response message in the historical interaction process.

The evaluation message may be a score or an acceptance degree; or may be a matching degree between the response message and the historical input message or the like.

Exemplarily, for the evaluation message of any response message generated by any target large language model, in response to determining that based on the evaluation message, the confidence of any response message is satisfied (indicating that any response message is credible), any response message may be outputted; otherwise, any response message may be not outputted.

The confidence level of any response message may include the average of at least a part of the historical scores (e.g., historical scores within a preset time period) corresponding to any response message is greater than a target score.

Or, among at least a part of the historical acceptance degrees (e.g., historical acceptance degrees within a preset time period) corresponding to any response message, the historical acceptance degree exceeding the first specified number may be greater than a target acceptance degree.

Or, among the matching degrees of any response message and at least a part of the historical input messages (e.g., historical input messages within a preset time period), the matching degree exceeding the second specified number may be greater than a target matching degree and the like.

In an optional embodiment, another implementation manner of outputting the second response message may be that the plurality of response messages generated sequentially by the plurality of target large language models may be obtained, and the response message generated by the last target large language model may be outputted as the second response message.

The last target large language model may have a higher matching degree with the target input message than previous target large language model.

In one embodiment, the target large language model may be determined multiple times, and only one target large language model may be determined each time. Based on the above, after the target large language model is determined for the first time, the first response message may be inputted into the target large language model determined for the first time, and the response message generated by the target large language model determined for the first time (referred to as the first response message) may be obtained. Subsequently, next target large language model may be determined according to the response message generated by the latest determined target large language model, and the new response message generated by next target large language model may be obtained, and the matching degree between new response message and the target input message may be higher than the matching degree between the response message generated by the target large language model determined the last time and the target input message. The domain to which the target large language model determined for the (i+1)-th time belongs may be a subdomain of the domain to which the target large language model determined for the i-th time belongs. That is, in the response messages generated by using the target large language model twice in a row, the response message generated by using the target large language model for the latter time may be more professional. i may be a positive integer greater than 0. The target large language model determined for the i-th time may be obtained by training the first domain knowledge base, and the target large language model determined for the (i+1)-th time may be obtained by training the second domain knowledge base. The domain to which the second domain knowledge base belongs may be a subdomain of the domain to which the first domain knowledge base belongs.

Optionally, after obtaining the response message generated by the i-th target large language model, the domain to which the response message generated by the i-th target large language model belongs may be obtained (the domain to which the response message belongs may be determined according to the intent message of the response message; or may be determined directly according to the response message; and corresponding implementation manner may refer to above-mentioned embodiments). Next, the large language model (not the first large language model) with same domain as the response message generated by the i-th target large language model may be determined as the (i+1)-th target large language model, and the response message generated by the i-th target large language model may be inputted into the (i+1)-th target large language model to obtain the response message generated by the (i+1)-th target large language model.

The total number of target large language models may be predetermined or determined according to actual conditions. For example, in response to that the matching degree between the response message generated by the i-th target large language model and the target input message is greater than or equal to a matching degree threshold, the i-th target large language model may be determined to be the last target large language model, that is, the number of target large language models may be i. In response to that the matching degree between the response message generated by the i-th target large language model and the target input message is less than the matching degree threshold, it needs to determine next target large language model to process the response message generated by the i-th target large language model until the matching degree between the response message generated by determined target large language model and the target input message is greater than or equal to the matching degree threshold.

For above-mentioned two implementation manners of outputting the second response message, only one implementation manner may be deployed, or two or three implementation manners may be deployed simultaneously. In the case of deploying two or three implementation manners simultaneously, only one implementation manner may be selected to output the second response message each time.

In an optional embodiment, another implementation manner of outputting the second response message disclosed above may be that based on the configuration message of an output module of the electronic device, the second response message may be processed into target media data for output.

The output module of the electronic device may include, but may be not limited to, at least one of the following: a display, a speaker and the like.

Exemplarily, the second response message may be processed into text and voice for broadcast, or the second response message may be processed into a picture for display, or the second response message may be processed into a video or animation for output and the like.

Some optional implementation manners of the present disclosure are described in combination with examples hereinafter.

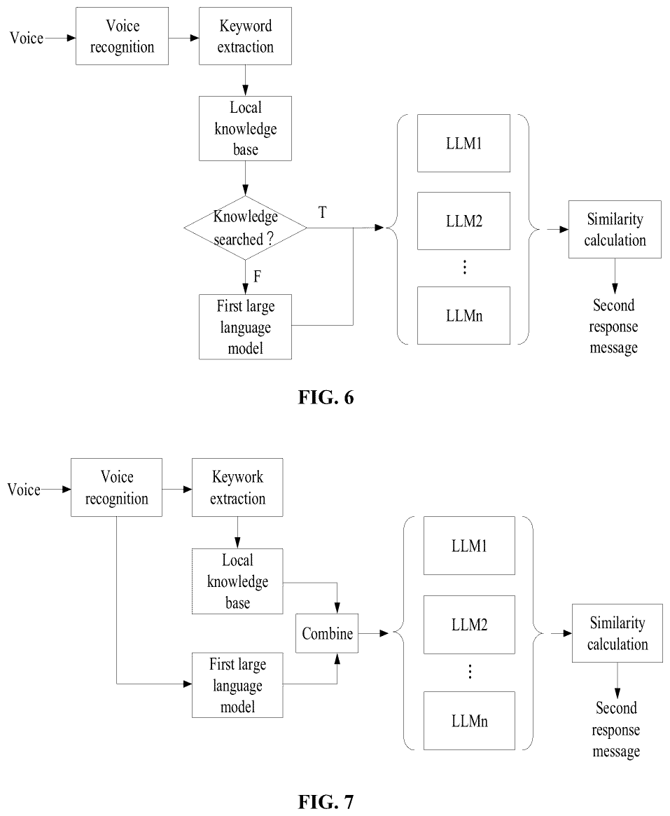

As shown in FIG. 6, FIG. 6 illustrates another implementation flowchart of an information processing method according to various embodiments of the present disclosure. The method may include following exemplary steps.

Voice input may be obtained.

Voice input may be identified to obtain text.

Keyword extraction may be performed on the identified text, and the extracted keyword may be inputted into the local knowledge base.

In response to that knowledge corresponding to at least one keyword is found (indicated by T in FIG. 6), the searched knowledge may be inputted as the first response message to at least one target large language model (LLM1˜LLMn in FIG. 6); in response to that no knowledge corresponding to any keyword is found (indicated by F in FIG. 6), the extracted keyword or identified text may be inputted into the first large language model, and the response message generated by the first large language model may be inputted as the first response message to at least one target large language model. The domain to which at least one target large language model belongs may be same as the domain to which above-mentioned identified text belongs. The domain to which above-mentioned identified text belongs may be determined according to above-mentioned identified text or corresponding intent message. Corresponding determination process may refer to above-mentioned embodiments, which may not be described in detail herein.

In response to that there are at least two target large language models, the similarity of the response messages generated by two target large language models may be calculated, and two response messages with the highest similarity may be outputted as the second response message for the user to view.

As shown in FIG. 7, FIG. 7 illustrates another implementation flowchart of an information processing method according to various embodiments of the present disclosure. The method may include following exemplary steps.

Voice input may be obtained.

Voice input may be identified to obtain text.

Keyword extraction may be performed on the identified text, the extracted keyword may be inputted into the local knowledge base, the third response message outputted by the local knowledge base may be obtained, the identified text may be inputted into the first large language model (obviously, the extracted keyword may also be inputted into the first large language model), and the fourth response message generated by the first large language model may be obtained.

A new prompt (i.e., the first response message) by combining the third response message and the fourth response message may be inputted into at least one target large language model. The domain to which at least one target large language model belongs may be same as the domain to which above-mentioned identified text belongs. The domain to which above-mentioned identified text belongs may be determined according to above-mentioned identified text or corresponding intent message. Corresponding determination process may refer to above-mentioned embodiments, which may not be described in detail herein. The new prompt may instruct each target large language model to continue writing on the basis of the third response message and the fourth response message and add more details, thereby generating a more detailed and rich answer.

In response to that there are at least two target large language models, the similarity of the response messages generated by two target large language models may be calculated, and two response messages with the highest similarity may be outputted as the second response message for the user to view.

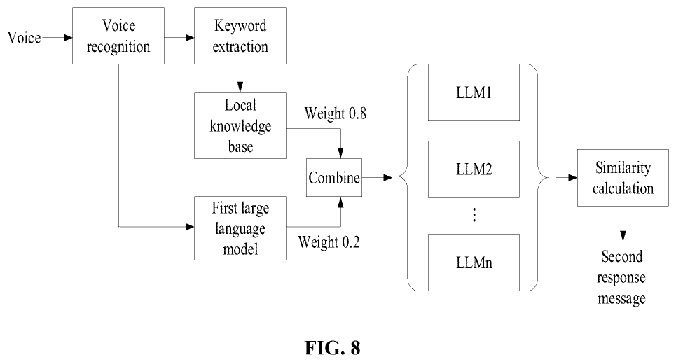

As shown in FIG. 8, FIG. 8 illustrates another implementation flowchart of an information processing method according to various embodiments of the present disclosure. The method may include following exemplary steps.

Voice input may be obtained.

Voice input may be identified to obtain text.

Keyword extraction may be performed on the identified text, the extracted keyword may be inputted into the local knowledge base, the third response message outputted by the local knowledge base may be obtained, the identified text may be inputted into the first large language model (obviously, the extracted keyword may also be inputted into the first large language model), and the fourth response message generated by the first large language model may be obtained.

Different weights may be assigned to the third response message and the fourth response message, respectively, where the weight of the third response message may be greater than the weight of the fourth response message. In one embodiment, the weight of the third response message may be 0.8, and the weight of the fourth response message may be 0.2.

A new prompt (i.e., the first response message) by combining the third response message and corresponding weight with the fourth response message and corresponding weight may be inputted into at least one target large language model. The domain to which at least one target large language model belongs may be same as the domain to which above-mentioned identified text belongs. The domain to which above-mentioned identified text belongs may be determined according to above-mentioned identified text or corresponding intent message. Corresponding determination process may refer to above-mentioned embodiments, which may not be described in detail herein. The new prompt may instruct each target large language model to continue writing on the basis of the third response message and the fourth response message and add more details, thereby generating a more detailed and rich answer.

Different from the example shown in FIG. 7, the example shown in FIG. 8 may show that the data extracted from the database is more accurate and meets the needs of the user. Therefore, a higher weight may be assigned to the third response message (the value range may be between 0.7 and 0.8, including the endpoint values), and a lower weight may be assigned to the fourth response message, which may generate a richer answer based on precise data of the database than the third response message and the fourth response message.

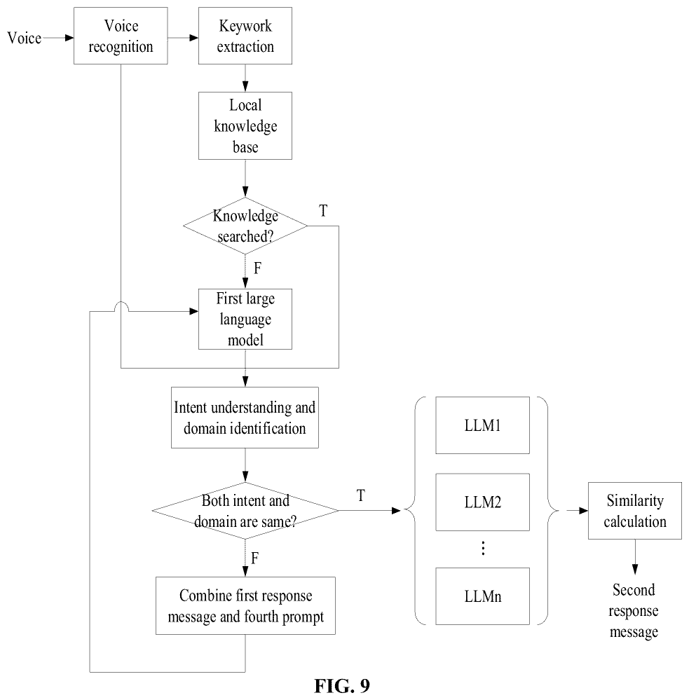

As shown in FIG. 9, FIG. 9 illustrates another implementation flowchart of an information processing method according to various embodiments of the present disclosure. The method may include following exemplary steps.

Voice input may be obtained.

Voice input may be identified to obtain text.

Keyword extraction may be performed on the identified text, and the extracted keyword may be inputted into the local knowledge base.

In response to that the knowledge corresponding to at least one keyword is searched and found, the searched knowledge may be configured as the first response message; and in response to that no knowledge corresponding to any keyword is searched and found, the extracted keyword or the identified text may be inputted into the first large language model, and the response message generated by the first large language model may be configured as the first response message.

Intent understanding and domain identification may be performed on the identified text (corresponding implementation manner may be referred to above-mentioned embodiments, which may not be described in detail herein) to obtain the first intent message and the first domain; Intent understanding and domain identification may be performed on the first response message to obtain the second intent message and the second domain.

In response to that the first intent message is same as the second intent message, and the first domain is same as the second domain, at least one target large language model may be determined, and the domain to which the target large language model belongs may be the first domain. Otherwise, the first response message and the fourth prompt may be inputted into the first large language model, such that the first large language model may supplement or amend the first response message, and the intent message and the domain of the supplemented or amended first response message may be same as the intent message and the domain of the identified text; and at least one target large language model may be determined. Exemplarily, the fourth prompt may be “determine whether above content is correct; in response to that it is correct, supplement the content; and in response to that it is wrong, correct the content”.

Optionally, when there are at least two target large language models, at least two target large language models may be determined simultaneously or sequentially; and corresponding determination manner may refer to above-mentioned embodiments.

When at least two target large language models are determined simultaneously, the similarity of the response messages generated by two target large language models may be calculated, and two response messages with the highest similarity may be outputted as the second response message for the user to view.

When at least two target large language models are determined sequentially, the response message generated by the last target large language model may be outputted as the second response message.

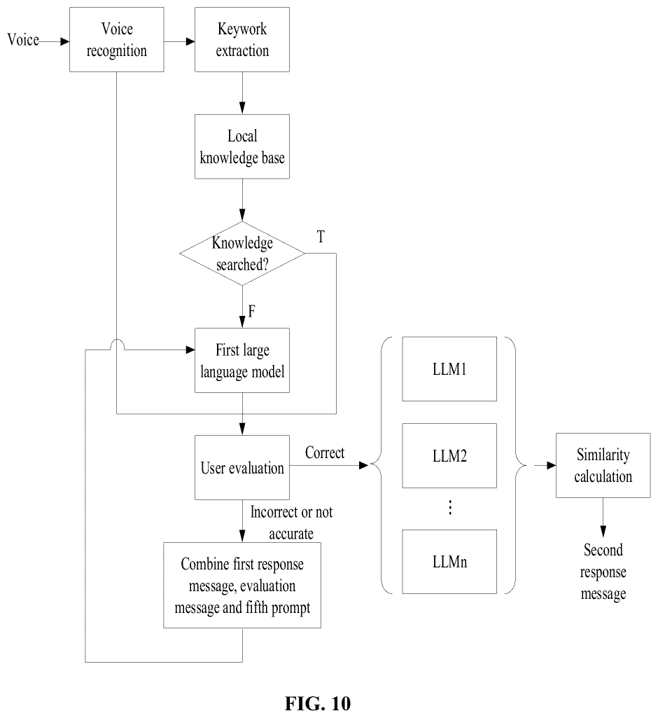

As shown in FIG. 10, FIG. 10 illustrates another implementation flowchart of an information processing method according to various embodiments of the present disclosure. The method may include following exemplary steps.

Voice input may be obtained.

Voice input may be identified to obtain text.

Keyword extraction may be performed on the identified text, and the extracted keyword may be inputted into the local knowledge base.

In response to that the knowledge corresponding to at least one keyword is searched and found, the searched knowledge may be configured as the first response message; and in response to that no knowledge corresponding to any keyword is searched and found, the extracted keyword or identified text may be inputted into the first large language model, and the response message generated by the first large language model may be configured as the first response message.

The first response message may be outputted, and the evaluation page may be displayed to obtain the evaluation message for the first response message. Exemplarily, the evaluation page may be configured to obtain the acceptance degree message inputted by the user for the first response message, and the acceptance degree may include, but may be not limited to, the following: wrong, correct, not accurate enough and the like.

Evaluation message for the first response message may be obtained. In response to that the evaluation message is correct, the second domain to which the first response message belongs may be obtained, at least one target large language model may be obtained, and the domain to which the target large language model belongs may be the second domain; in response to that the evaluation message is wrong or not accurate enough, the first response message, the evaluation message and the fifth prompt may be inputted into the first large language model, such that the first large language model may supplement or amend the first response message until the evaluation message received based on the supplemented or amended first response message is correct; and at least one target large language model may be determined based on the domain to which the latest generated first response message belongs.

Optionally, when there are at least two target large language models, at least two target large language models may be determined simultaneously or sequentially; and corresponding determination manner may refer to above-mentioned embodiments.

When at least two target large language models are determined simultaneously, the similarity of the response messages generated by two target large language models may be calculated, and two response messages with the highest similarity may be outputted as the second response message for the user to view.

When at least two target large language models are determined sequentially, the response message generated by the last target large language model may be outputted as the second response message.

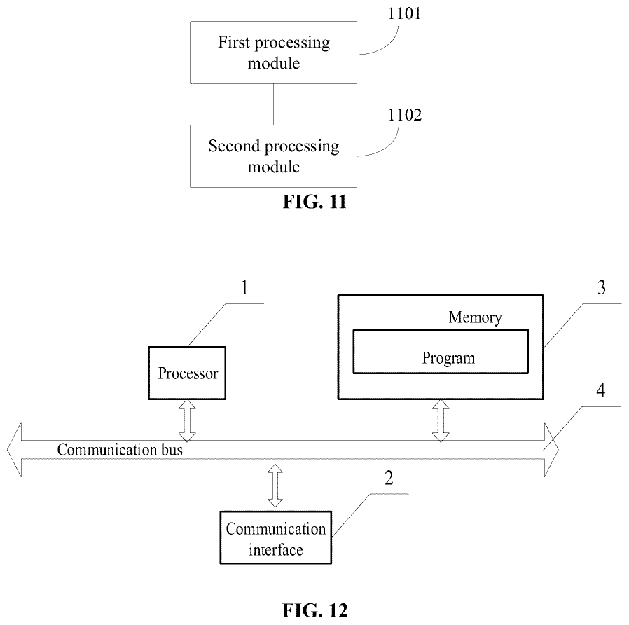

Corresponding to method embodiments, the present disclosure also provides an information processing apparatus. A structural schematic of the information processing apparatus provided by embodiments of the present disclosure is shown in FIG. 11. The information processing apparatus may include the first processing module 1101 and the second processing module 1102.

The first processing module 1101 may be configured to output the first response message based on the target knowledge base in response to the obtaining of the target input message.

The second processing module 1102 may be configured to input the first response message into at least one target large language model and output the second response message.

The target large language model may be different from the target knowledge base, and the matching degree between the second response message and the target input message may be higher than the matching degree between the first response message and the target input message.

For the information processing apparatus provided in embodiments of the present disclosure, the target input message may not be directly inputted into the large language model, but the first response message may be first obtained based on the target knowledge base, and the first response message may be processed through one or more target large language models to obtain the second response message, such that the second response message may have a higher matching degree with the target input message, thereby improving the reliability of human-computer interaction.

In an optional embodiment, the first processing module 1101 may be exemplarily configured for at least one of the following: in response to the obtaining of the target input message, extracting the keyword from the target input message, inputting the extracted keyword into the local knowledge base of the electronic device and/or the first large language model to output the first response message; in response to the obtaining of the target input message, after the enhancement processing is performed on the target input message, inputting enhanced target input message into the local knowledge base of the electronic device and/or the first large language model to output the first response message; and in response to the obtaining of the target input message, determining to output the first response message using the local knowledge base of the electronic device and/or the first large language model based on the attribute message and/or content of the target input message.

The first large language model may be trained based on the first knowledge base different from the local knowledge base.

In an optional embodiment, when inputting enhanced target input message into the local knowledge base of the electronic device and/or the first large language model to output the first response message, the first processing module 1101 may be configured for at least one of the following: after extracting the keyword from the target input message, keyword expansion processing may be performed and/or intent expansion processing may be performed on the target input message, and the message data after expansion processing may be inputted into the local knowledge base of the electronic device or the first large language model to output the first response message; after extracting the keyword from the target input message, the response message matching the keyword may be obtained from the local knowledge base of the electronic device, and in response to that matching response message is not obtained, after performing the keyword expansion processing, a keyword expansion processing result may be inputted into the local knowledge base or the first large language model to output the first response message; and after extracting the keyword from the target input message, the response message matching the keyword may be obtained from the local knowledge base of the electronic device, and in response to that no matching response message is obtained, the target input message after the intent expansion processing may be inputted into the first large language model to output the first response message.

In an optional embodiment, when determining to output the first response message using the local knowledge base of the electronic device and/or the first large language model based on the attribute message and/or content of the target input message, the first processing module 1101 may be configured for at least one of the following: based on the format attribute of the target input message and/or the intent content characterized, determining to output the first response message using the local knowledge base of the electronic device and/or the first large language model; based on the source attribute of the target input message and/or the intent content characterized, determining to output the first response message using the local knowledge base of the electronic device and/or the first large language model; and based on the data volume attribute of the target input message and/or the instruction content carried, determine to output the first response message using the local knowledge base of the electronic device and/or the first large language model.

In an optional embodiment, the first processing module 1101 may be exemplarily configured to: in response to the obtaining target input message, input the target input message into the local knowledge base and the first large language model of the electronic device respectively, perform the target processing on the response messages respectively outputted by the local knowledge base and the first large language model, and output the first response message.

The first large language model may be trained based on the first knowledge base different from the local knowledge base.

In an optional embodiment, when performing the target processing on the response messages respectively outputted by the local knowledge base and the first large language model and outputting the first response message, the first processing module 1101 may be configured for at least one of the following: different weights may be respectively configured for the third response message outputted by the local knowledge base and the fourth response message outputted by the first large language model, and the third response message and the fourth response message may be integrated based on corresponding weights to obtain the first response message; the match processing may be performed on the third response message outputted by the local knowledge base and the fourth response message outputted by the first large language model, the response message that the matching degree reaches the first threshold may be determined as the first response message; the evaluation message of the third response message outputted by the local knowledge base and the fourth response message outputted by the first large language model may be obtained, and at least a part of the third response message and/or the fourth response message may be outputted as the first response message based on the evaluation message; and the third response message outputted by the local knowledge base and the fourth response message outputted by the first large language model may be superimposed to obtain the first response message.

In an optional embodiment, when inputting the first response message into at least one target large language model and outputting the second response message, the second processing module 1102 may be configured to: input the first response message into the plurality of target large language models respectively to generate the plurality of response messages; and compare the similarities between the response messages outputted by all target large language models, and output the response message with the highest similarity as the second response message.

In an optional embodiment, when inputting the first response message into at least one target large language model, the second processing module 1102 may be configured for at least one of the following: the intent message characterized by the target input message and/or the first response message may be identified, the target large language model may be determined based on the intent message, the first response message may be inputted into at least one determined target large language model, the domain to which the target large language model belongs may be same as the domain to which the target input message and/or the first response message belong; the domains to which the target input message and the first response message belong may be identified, and in response to that the domains to which the target input message and the first response message belong are same, the first response message may be inputted into at least one target large language model with same domain; and the evaluation message of the first response message may be obtained, the target large language model may be determined based on the evaluation message and the domain to which the first response message belongs, and the first response message may be inputted into at least one determined target large language model.

In an optional embodiment, when outputting the second response message, the second processing module 1102 may be configured for at least one of the following: the evaluation message of the plurality of response messages generated by the plurality of target large language models may be obtained, and at least one of the plurality of response messages may be determined as the second response message based on the evaluation message; the plurality of response messages generated by the plurality of target large language models in sequence may be obtained, and the response message generated by the last target large language model may be outputted as the second response message, where the last target large language model may have a higher matching degree with the target input message than previous target large language model; and based on the configuration message of the output module of the electronic device, the second response message may be processed into target media data for output.

Corresponding to method embodiments, the present disclosure also provides an electronic device. A structural schematic of the electronic device is shown in FIG. 12. The electronic device may include at least one processor 1, at least one communication interface 2, at least one memory 3 and at least one communication bus 4.

In embodiments of the present disclosure, the number of the processors 1, the communication interfaces 2, the memory 3, and the communication buss 4 may be at least one; and the processor 1, the communication interface 2, and the memory 3 may communicate with each other through the communication bus 4.

The processor 1 may be a central processing unit (CPU), or an application specific integrated circuit (ASIC), or one or more integrated circuits configured to implement embodiments of the present disclosure.

The memory 3 may include a high-speed RAM memory; and may also include a non-volatile memory, such as at least one disk memory.

The memory 3 may store a program, and the processor 1 may call the program stored in the memory 3. The program may be configured to, in response to the obtaining of the target input message, output the first response message based on the target knowledge base; and input the first response message into at least one target large language model, and output the second response message.

The target large language model may be different from the target knowledge base, and the matching degree between the second response message and the target input message may be higher than the matching degree between the first response message and the target input message.

Optionally, detailed functions and extended functions of the program may refer to above description.

Embodiments of the present disclosure also provides a storage medium, which may store a program suitable for execution by a processor. The program may be configured to, in response to the obtaining target input message, output first response message based on the target knowledge base; and input the first response message into at least one target large language model, and output second response message.

The target large language model may be different from the target knowledge base, and the matching degree between the second response message and the target input message may be higher than the matching degree between the first response message and the target input message.

Optionally, detailed functions and extended functions of the program may refer to above description.

Various embodiments of the present disclosure further provide an electronic device. The electronic device includes a memory, configured to store a computer program; and one or more processors, configured to, when the computer program is executed, perform an information processing method. The method includes in response to the obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

Various embodiments of the present disclosure further provide a non-transitory computer-readable storage medium, containing a computer program for when executed by one or more processors, performing an information processing method. The method includes in response to the obtaining of a target input message, outputting a first response message based on a target knowledge base; and inputting the first response message into at least one target large language model, and outputting a second response message, where the at least one target large language model is different from the target knowledge base; and a matching degree between the second response message and the target input message is higher than a matching degree between the first response message and the target input message.

Compared with the existing technology, the technical solutions provided by the present disclosure may achieve at least the following beneficial effects.

As disclosed above, the electronic device and the storage medium provided by the present disclosure, the first response message may be outputted based on the target knowledge base in response to the obtaining of the target input message; and the first response message may be inputted into at least one target large language model, and the second response message may be outputted. The target large language model may be different from the target knowledge base; and the matching degree between the second response message and the target input message may be higher than the matching degree between the first response message and the target input message. For the present disclosure, the target input message may be no longer directly inputted into the large language model, but the first response message may be first obtained based on the target knowledge base; and the first response message may be processed through one or more target large language models to obtain the second response message. In such way, the second response message may have a higher matching degree with the target input message, thereby improving the reliability of human-computer interaction.

Those skilled in the art may realize that the units and algorithm steps of each example described in embodiments of the present disclosure may be implemented in electronic hardware or in combination with computer software and electronic hardware. Whether above functions are performed in hardware or software depends on certain application and design constraints of the technical solutions. Those skilled in the art may use different methods to implement described functions for each application, but such implementation should not be considered to be beyond the scope of the present disclosure.

In some embodiments provided in the present disclosure, it should be understood that the disclosed systems, apparatuses and methods may be implemented in other manners. Furthermore, the mutual coupling or direct coupling or communication connection shown or discussed may be indirect coupling or communication connection through certain interfaces, apparatuses or units, which may be electrical, mechanical or other forms.

The units described as separate components may or may not be physically separated, and the components displayed as units may or may not be physical units, that is, above components may be located in one place or may be distributed on a plurality of network units. Some or all of the units may be selected according to actual needs to achieve the purpose of the solutions of embodiments of the present disclosure.

In addition, each functional unit in each embodiment of the present disclosure may be integrated into a processing unit; or each unit may exist physically separately; or two or more units may be integrated into one unit.

It should be understood that in embodiments of the present disclosure, the claims, various embodiments, and features may be combined with each other to achieve the solutions of above-mentioned technical problems.

When the functions are implemented in the form of software functional units and sold or configured as independent products, the functions may be stored in a computer-readable storage medium. Based on such understanding, the essence of the technical solution of the present disclosure, or a part of the technical solution which may contribute to the existing technology, or a part of the technical solution may be embodied in the form of a software product. The computer software product may be stored in a storage medium and include certain instructions for a computer device (which may be a personal computer, a server, or a network device or the like) to perform all or part of exemplary steps of the methods described in each embodiment of the present disclosure. Above-mentioned storage media may include various media capable of storing program codes, including U disk, mobile hard disk, read-only memory (ROM), random access memory (RAM), disk, optical disk or the like.

Above description of disclosed embodiments may make those skilled in the art to implement or use the present disclosure. Various modifications to above-mentioned embodiments may be apparent to those skilled in the art, and the principles defined in the present disclosure may be implemented in other embodiments without departing from the spirit or scope of the present disclosure. Therefore, the present disclosure may not be limited to embodiments in the present disclosure but may conform to the widest scope consistent with the principles and novel features in the present disclosure.

What is claimed is:

1. An information processing method, comprising:
in response to obtaining of a target input message, outputting a first response message based on a target knowledge base; and
inputting the first response message into at least one target large language model, and outputting a second response message, wherein the at least one target large language model is different from the target knowledge base; and a matching degree between the second response message and the target input message is higher than a matching degree between the first response message and the target input message.

2. The method according to claim 1, wherein in response to the obtaining of the target input message, outputting the first response message based on the target knowledge base includes at least one of following:
in response to the obtaining of the target input message, extracting a keyword from the target input message, and inputting extracted keyword into a local knowledge base of an electronic device and/or a first large language model to output the first response message;
in response to the obtaining of the target input message, after an enhancement processing is performed on the target input message, inputting enhanced target input message into the local knowledge base of the electronic device and/or the first large language model to output the first response message; or
in response to the obtaining of the target input message, determining to output the first response message using the local knowledge base of the electronic device and/or the first large language model based on an attribute message and/or content of the target input message, wherein the first large language model is trained based on a first knowledge base different from the local knowledge base.

3. The method according to claim 2, wherein inputting the enhanced target input message into the local knowledge base of the electronic device and/or the first large language model to output the first response message after the enhancement processing is performed on the target input message includes at least one of following:
performing a keyword expansion processing after extracting the keyword from the target input message and/or performing an intent expansion processing on the target input message, and inputting message data after expansion processing into the local knowledge base of the electronic device or the first large language model to output the first response message;
after extracting the keyword from the target input message, obtaining a response message matching the keyword from the local knowledge base of the electronic device; and in response to that the response message matching the keyword is not obtained, after performing the keyword expansion processing, inputting a keyword expansion processing result into the local knowledge base or the first large language model to output the first response message; or
after extracting the keyword from the target input message, obtaining the response message matching the keyword from the local knowledge base of the electronic device; and in response to that the response message matching the keyword is not obtained, inputting the target input message after performing the intent expansion processing into the first large language model to output the first response message.

4. The method according to claim 2, wherein determining to output the first response message using the local knowledge base of the electronic device and/or the first large language model based on the attribute message and/or the content of the target input message includes at least one of following:
determining to output the first response message using the local knowledge base of the electronic device and/or the first large language model based on a format attribute of the target input message and/or intent content characterized by the target input message;
determining to output the first response message using the local knowledge base of the electronic device and/or the first large language model based on a source attribute of the target input message and/or the intent content characterized by the target input message; or
determining to output the first response message using the local knowledge base of the electronic device and/or the first large language model based on a data volume attribute of the target input message and/or instruction content carried by the target input message.

5. The method according to claim 1, wherein in response to the obtaining of the target input message, outputting the first response message based on the target knowledge base includes:
in response to the obtaining of the target input message, inputting the target input message into a local knowledge base of an electronic device and a first large language model respectively; and outputting the first response message after target processing is performed on response messages respectively outputted by the local knowledge base and the first large language model, wherein the first large language model is trained based on a first knowledge base different from the local knowledge base.

6. The method according to claim 5, wherein outputting the first response message after the target processing is performed on the response messages respectively outputted by the local knowledge base and the first large language model includes at least one of following:
configuring different weights for a third response message outputted by the local knowledge base and a fourth response message outputted by the first large language model, respectively; and performing an integration processing on the third response message and the fourth response message based on corresponding weights to obtain the first response message;
performing a match processing on the third response message outputted by the local knowledge base and the fourth response message outputted by the first large language model;
and determining a response message that a matching degree exceeds a first threshold as the first response message;
obtaining an evaluation message of the third response message outputted by the local knowledge base and the fourth response message outputted by the first large language model; and based on the evaluation message, outputting at least a part of the third response message and/or the fourth response message as the first response message; or
performing a superimposing processing on the third response message outputted by the local knowledge base and the fourth response message outputted by the first large language model to obtain the first response message.

7. The method according to claim 1, wherein inputting the first response message into the at least one target large language model and outputting the second response message includes:
inputting the first response message to a plurality of target large language models respectively to generate a plurality of response messages; and
comparing similarities between the plurality of response messages outputted by the plurality of target large language models and outputting a response message with a highest similarity as the second response message.

8. The method according to claim 1, wherein inputting the first response message into the at least one target large language model includes at least one of following:
identifying an intent message characterized by the target input message and/or the first response message, determining the at least one target large language model based on the intent message, and inputting the first response message into the at least one target large language model determined, wherein a domain to which the at least one target large language model belongs is same as a domain to which the target input message and/or the first response message belongs;
identifying domains to which the target input message and the first response message belong; and in response to that the domains to which the target input message and the first response message belong are same, inputting the first response message into at least one target large language model with a same domain as the first response message; or
obtaining an evaluation message of the first response message; determining the at least one target large language model based on domains to which the evaluation message and the first response message belong; and inputting the first response message into the at least one target large language model determined.

9. The method according to claim 8, wherein outputting the second response message includes at least one of following:
obtaining an evaluation message of a plurality of response messages generated by a plurality of target large language models; and based on the evaluation message, determining at least one of the plurality of response messages as the second response message;
obtaining the plurality of response messages generated by the plurality of target large language models in sequence, and outputting a response message generated by a last target large language model as the second response message, wherein the last target large language model has a higher matching degree with the target input message than a previous target large language model; or
based on configuration message of an output module of an electronic device, processing the second response message into target media data for output.

10. An electronic device, comprising:
a memory, configured to store a computer program; and
one or more processors, configured to, when the computer program is executed, perform:
in response to obtaining of a target input message, outputting a first response message based on a target knowledge base; and
inputting the first response message into at least one target large language model, and outputting a second response message, wherein the at least one target large language model is different from the target knowledge base; and a matching degree between the second response message and the target input message is higher than a matching degree between the first response message and the target input message.

11. The electronic device according to claim 10, wherein for outputting the first response message based on the target knowledge base in response to the obtaining of the target input message, the one or more processors are configured to preform at least one of following:
in response to the obtaining of the target input message, extracting a keyword from the target input message, and inputting extracted keyword into a local knowledge base of an electronic device and/or a first large language model to output the first response message;
in response to the obtaining of the target input message, after an enhancement processing is performed on the target input message, inputting enhanced target input message into the local knowledge base of the electronic device and/or the first large language model to output the first response message; or
in response to the obtaining of the target input message, determining to output the first response message using the local knowledge base of the electronic device and/or the first large language model based on an attribute message and/or content of the target input message, wherein the first large language model is trained based on a first knowledge base different from the local knowledge base.

12. The electronic device according to claim 11, wherein for inputting the enhanced target input message into the local knowledge base of the electronic device and/or the first large language model to output the first response message after the enhancement processing is performed on the target input message, the one or more processors are configured to preform at least one of following:
performing a keyword expansion processing after extracting the keyword from the target input message and/or performing an intent expansion processing on the target input message, and inputting message data after expansion processing into the local knowledge base of the electronic device or the first large language model to output the first response message;
after extracting the keyword from the target input message, obtaining a response message matching the keyword from the local knowledge base of the electronic device; and in response to that the response message matching the keyword is not obtained, after performing the keyword expansion processing, inputting a keyword expansion processing result into the local knowledge base or the first large language model to output the first response message; or
after extracting the keyword from the target input message, obtaining the response message matching the keyword from the local knowledge base of the electronic device; and in response to that the response message matching the keyword is not obtained, inputting the target input message after performing the intent expansion processing into the first large language model to output the first response message.

13. The electronic device according to claim 11, wherein for determining to output the first response message using the local knowledge base of the electronic device and/or the first large language model based on the attribute message and/or the content of the target input message, the one or more processors are configured to preform at least one of following:
determining to output the first response message using the local knowledge base of the electronic device and/or the first large language model based on a format attribute of the target input message and/or intent content characterized by the target input message;
determining to output the first response message using the local knowledge base of the electronic device and/or the first large language model based on a source attribute of the target input message and/or the intent content characterized by the target input message; or
determining to output the first response message using the local knowledge base of the electronic device and/or the first large language model based on a data volume attribute of the target input message and/or instruction content carried by the target input message.

14. The electronic device according to claim 10, wherein for outputting the first response message based on the target knowledge base in response to the obtaining of the target input message, the one or more processors are configured to:
in response to the obtaining of the target input message, input the target input message into a local knowledge base of an electronic device and a first large language model respectively;
and output the first response message after target processing is performed on response messages respectively outputted by the local knowledge base and the first large language model, wherein the first large language model is trained based on a first knowledge base different from the local knowledge base.

15. The electronic device according to claim 14, wherein for outputting the first response message after the target processing is performed on the response messages respectively outputted by the local knowledge base and the first large language model, the one or more processors are configured to preform at least one of following:
configuring different weights for a third response message outputted by the local knowledge base and a fourth response message outputted by the first large language model, respectively; and performing an integration processing on the third response message and the fourth response message based on corresponding weights to obtain the first response message;
performing a match processing on the third response message outputted by the local knowledge base and the fourth response message outputted by the first large language model; and determining a response message that a matching degree exceeds a first threshold as the first response message;
obtaining an evaluation message of the third response message outputted by the local knowledge base and the fourth response message outputted by the first large language model; and based on the evaluation message, outputting at least a part of the third response message and/or the fourth response message as the first response message; or
performing a superimposing processing on the third response message outputted by the local knowledge base and the fourth response message outputted by the first large language model to obtain the first response message.

16. The electronic device according to claim 10, wherein for inputting the first response message into the at least one target large language model and outputting the second response message, the one or more processors are configured to:
input the first response message to a plurality of target large language models respectively to generate a plurality of response messages; and
compare similarities between the plurality of response messages outputted by the plurality of target large language models and output a response message with a highest similarity as the second response message.

17. The electronic device according to claim 10, wherein for inputting the first response message into the at least one target large language model, the one or more processors are configured to preform at least one of following:
identifying an intent message characterized by the target input message and/or the first response message, determining the at least one target large language model based on the intent message, and inputting the first response message into the at least one target large language model determined, wherein a domain to which the at least one target large language model belongs is same as a domain to which the target input message and/or the first response message belongs;
identifying domains to which the target input message and the first response message belong; and in response to that the domains to which the target input message and the first response message belong are same, inputting the first response message into at least one target large language model with a same domain as the first response message; or
obtaining an evaluation message of the first response message; determining the at least one target large language model based on domains to which the evaluation message and the first response message belong; and inputting the first response message into the at least one target large language model determined.

18. The electronic device according to claim 17, wherein for outputting the second response message, the one or more processors are configured to preform at least one of following:
obtaining an evaluation message of a plurality of response messages generated by a plurality of target large language models; and based on the evaluation message, determining at least one of the plurality of response messages as the second response message;
obtaining the plurality of response messages generated by the plurality of target large language models in sequence, and outputting a response message generated by a last target large language model as the second response message, wherein the last target large language model has a higher matching degree with the target input message than a previous target large language model; or
based on configuration message of an output module of an electronic device, processing the second response message into target media data for output.

19. A non-transitory computer-readable storage medium containing a computer program that when being executed, causes one or more processors to perform:
in response to obtaining of a target input message, outputting a first response message based on a target knowledge base; and
inputting the first response message into at least one target large language model, and outputting a second response message, wherein the at least one target large language model is different from the target knowledge base; and a matching degree between the second response message and the target input message is higher than a matching degree between the first response message and the target input message.

20. The storage medium according to claim 19, wherein for outputting the first response message based on the target knowledge base in response to the obtaining of the target input message, the one or more processors are configured to preform at least one of following:
in response to the obtaining of the target input message, extracting a keyword from the target input message, and inputting extracted keyword into a local knowledge base of an electronic device and/or a first large language model to output the first response message;
in response to the obtaining of the target input message, after an enhancement processing is performed on the target input message, inputting enhanced target input message into the local knowledge base of the electronic device and/or the first large language model to output the first response message; or
in response to the obtaining of the target input message, determining to output the first response message using the local knowledge base of the electronic device and/or the first large language model based on an attribute message and/or content of the target input message, wherein the first large language model is trained based on a first knowledge base different from the local knowledge base.
